(19) United States
(12) Patent Application Publication
(10) Pub. No.: US 2014/0375285 A1
(43) Pub. Date: Dec. 25, 2014

(54) DC-DC BOOST CONVERTER

(71) Applicant: ANPEC ELECTRONICS CORPORATION, Hsinchu City (TW)

(72) Inventors: CHIH-YUAN CHEN, HSINCHU CITY (TW); TZU-YANG YEN, TAIPEI CITY (TW)

(73) Assignee: ANPEC ELECTRONICS CORPORATION, Hsinchu City (TW)

(21) Appl. No.: 13/968,811

(22) Filed: Aug. 16, 2013

(30) Foreign Application Priority Data
Jun. 21, 2013 (TW) 102122133

(51) Int. Cl. H02M 3/158

(52) U.S. Cl. CPC H02M 3/158
USPC 323/271

(57) ABSTRACT

The present disclosure provides a DC-DC boost converter operating in a pulse frequency modulation mode. The DC-DC boost converter includes an inductor, a first switch, a capacitor, a second switch and a control circuit. The inductor is coupled between an input voltage node and a phase node. The first switch is coupled between the phase node and an output voltage node. The capacitor is coupled between the output voltage node and a ground. The second switch is coupled between the phase node and the ground. The control circuit controls the conducting status of the first switch and the second switch. The control circuit detects whether the voltage at the phase node is changed. When the voltage at the phase node is not changed during a predetermined time interval, the control circuit turns on the first switch. Therefore, the noise with frequency could be hear by human is avoided.

### BACKGROUND

1. Technical Field

The present disclosure relates to a converter, in particular, to a DC-DC boost converter.

2. Description of Related Art

Please refer to FIG. 1. FIG. 1 is a circuit diagram of a conventional DC-DC boost converter. The conventional DC-DC boost converter includes an inductor 11, a first switch 12, a capacitor 13, a second switch 14, a control circuit 15, a voltage division unit 16 and driving units 17, 18. The control circuit 15 controls the DC-DC boost converter to operate in a pulse width modulation mode (PWM mode) or a pulse frequency modulation mode (PFM mode). The pulse frequency modulation mode is suitable for the light load condition. The control circuit 15 obtains a feedback voltage FB corresponding to an output voltage Vout via a feedback node 104 of the voltage division unit 16. According to the feedback voltage FB, the control circuit 15 controls the conducting status of the first switch 12 and the second switch 14 through the driving units 17, 18 respectively to adjust the voltage level of the output voltage Vout. When the voltage level of the output voltage Vout is insufficient, the second switch 14 and the first switch 12 are sequentially switched on to make the inductor 11 charge the capacitor 13. When the voltage level of the output voltage Vout is sufficient, the second switch 14 and the first switch 12 will not be switched.

Please refer to FIG. 1 and FIG. 2. FIG. 2 is a waveform diagram of voltage and current during operation of the DC-DC boost converter shown in FIG. 1. When the second switch 14 is turned on due to a voltage change at a control node G2 of the second switch 14, an inductive current rises with a slope Vin/L; L is an inductance value of the inductor 11. When the second switch 14 is turned off, and the first switch 12 is turned on due to a voltage change at a control node G1 of the first switch 12, the inductive current falls with a slope (Vin−Vout)/L. It is worth mentioning that when the second switch 14 is turned on, the voltage level at a phase node 103 drops from the input voltage Vin to a voltage level close to a ground voltage (zero volts). After that when the second switch 14 is turned off and the first switch 12 is turned on, the voltage level at the phase node 103 changes from a voltage level close to the ground voltage (zero volts) to the output voltage Vout.

### SUMMARY

An exemplary embodiment of the present disclosure provides a DC-DC boost converter whose switches switch during a predetermined time interval to which the frequency corresponding is greater than the frequency range that the human ear can hear (greater than 20 kHz) so as to avoid generating the noise in the frequency that the human ear can hear during operation of the DC-DC boost converter.

An exemplary embodiment of the present disclosure provides a DC-DC boost converter operating in a pulse frequency modulation mode. The DC-DC boost converter comprises an inductor, a first switch, a capacitor, a second switch and a control circuit. The inductor is coupled between an input voltage node and a phase node. The first switch is coupled between the phase node and an output voltage node. The capacitor is coupled between the output voltage node and a ground. The second switch is coupled between the phase node and the ground. The control circuit controls the conducting status of the first switch and the second switch according to a feedback voltage responding to the voltage at the output voltage node. The control circuit detects whether the voltage at the phase node is changed during a predetermined time interval. When the voltage at the phase node is not changed during the predetermined time interval, the control circuit continues turning on the first switch for a conduction time.

An exemplary embodiment of the present disclosure provides a DC-DC boost converter operating in a pulse frequency modulation mode. The DC-DC boost converter comprises an inductor, a first switch, a capacitor, a second switch and a control circuit. The inductor is coupled between an input voltage node and a phase node. The first switch is coupled between the phase node and an output voltage node. The capacitor is coupled between the output voltage node and a ground. The second switch is coupled between the phase node and the ground. The control circuit controls the conducting status of the first switch and the second switch according to a feedback voltage responding to the voltage at the output voltage node. The control circuit detects whether the voltage at the phase node is changed during a predetermined time interval. When the voltage at the phase node is not changed during the predetermined time interval, the control circuit continues turning on the first switch until the feedback voltage is lower than a reference voltage.

An exemplary embodiment of the present disclosure provides a DC-DC boost converter operating in a pulse frequency modulation mode. The DC-DC boost converter comprises an inductor, a first switch, a capacitor, a second switch and a control circuit. The inductor is coupled between an input voltage node and a phase node. The first switch is coupled between the phase node and an output voltage node. The capacitor is coupled between the output voltage node and a ground. The second switch is coupled between the phase node and the ground. The control circuit controls the conducting status of the first switch and the second switch according to a feedback voltage responding to the voltage at the output voltage node. The control circuit detects whether the conducting status of the second switch is changed during a predetermined time interval. When the conducting status of the second switch is not changed during the predetermined time interval, the control circuit turns on the first switch.

To sum up, an exemplary embodiment of the present disclosure provides a DC-DC boost converter, which detects whether the voltage at the phase node is changed during a predetermined time interval. When the voltage at the phase node is not changed during the predetermined time interval, which represents the first switch and the second switch of the DC-DC boost converter are not switched (the conducting statuses are not changed) during the predetermined time interval, the control circuit turns on the first switch so as to avoid generating the noise in the frequency that the human ear can hear during operation of the DC-DC boost converter.

In order to further understand the techniques, means and effects of the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

FIG. 1 is a circuit diagram of a conventional DC-DC boost converter.

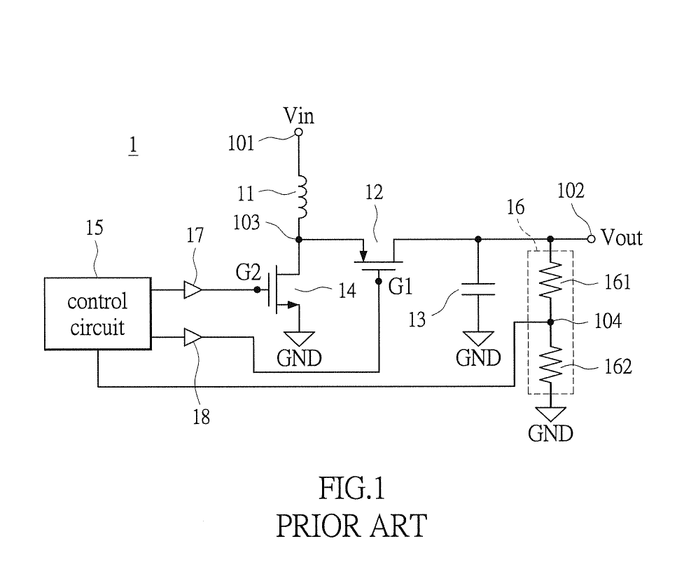

FIG. 2 is a waveform diagram of voltage and current during operation of the DC-DC boost converter shown in FIG. 1.

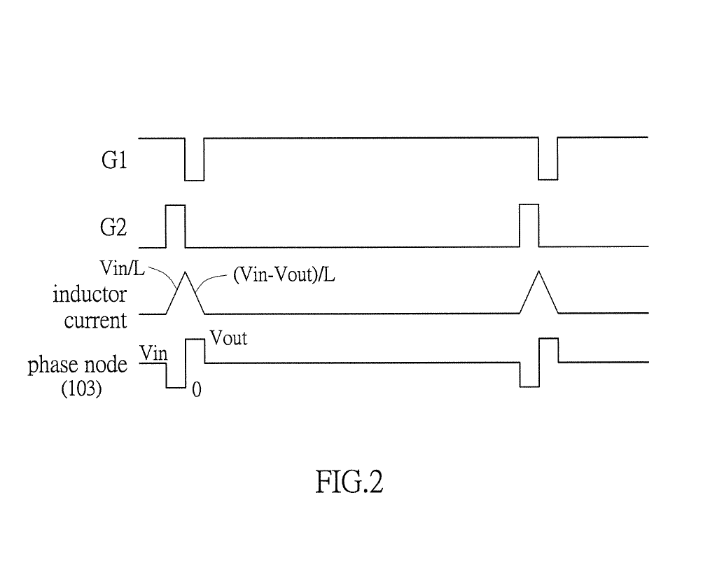

FIG. 3 is a circuit diagram of a DC-DC boost converter in an embodiment of the present disclosure.

FIG. 4 is an operation flow chart of a DC-DC boost converter in an embodiment of the present disclosure.

FIG. 5 is a waveform diagram of voltage and current during operation of a DC-DC boost converter in an embodiment of the present disclosure.

FIG. 6 is an operation flow chart of a DC-DC boost converter in another embodiment of the present disclosure.

FIG. 7 is a waveform diagram of voltage and current during operation of a DC-DC boost converter in another embodiment of the present disclosure.

### DESCRIPTION OF THE EXEMPLARY EMBODIMENTS

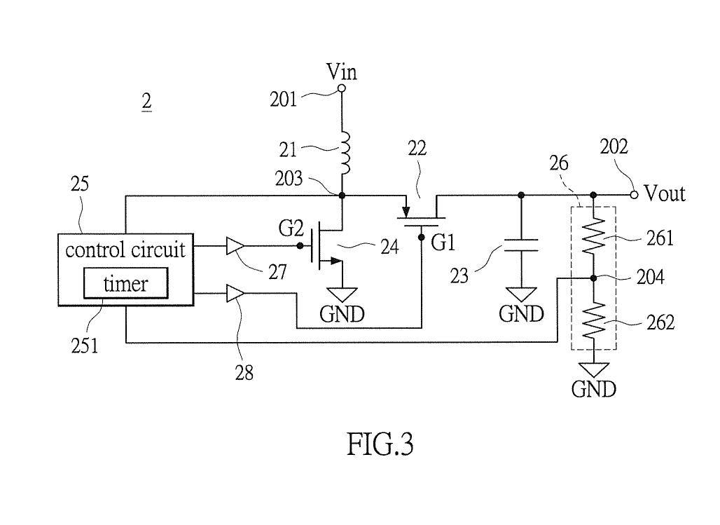

Referring to FIG. 3, FIG. 3 is a circuit diagram of a DC-DC boost converter in an embodiment of the present disclosure. The DC-DC boost converter 2 operates in a pulse frequency modulation mode (PFM mode). The DC-DC boost converter 2 comprises an inductor 21, a first switch 22, a capacitor 23, a second switch 24 and a control circuit 25, a voltage division unit 26 and driving units 27, 28. The driving units 27, 28 are utilized to provide the second switch 24 and the first switch 22with sufficient driving voltage. The driving units 27, 28 can change according to the type of the switches 22, 24, or can also be integrated into the control circuit 25.

The inductor 21 is coupled between an input voltage node 201 and a phase node 203. The first switch 22 is coupled between the phase node 203and an output voltage node 202. The capacitor 23 is coupled between the phase node 203 and a ground GND. The control circuit 25 is coupled to a control node G2 of the second switch 24 via the driving unit 27, and the control circuit 25 is coupled to a control node G1 of the first switch 22 via the driving unit 28. The control circuit 25 is coupled to the phase node 203 in order to detect the voltage at the phase node 203.

The voltage division unit 26 is used as a feedback circuit. The voltage division unit 26 is coupled to the output voltage node 202, and generates a feedback voltage FB according to a voltage Vout at the output voltage node 202. In detail, the voltage division unit 26 is composed of a resistor 261, which is coupled between an output voltage node 206 and a feedback node 204, and a resistor 262, which is coupled between the feedback node 204 and the ground GND. The voltage division unit 26 divides the voltage at the output voltage node 202 so as to generate the feedback voltage FB at the feedback node 204.

The control circuit 25 is according to the feedback voltage FB corresponding to the voltage Vout at the output voltage node 202 to control the conducting status of the first switch 22 and the second switch 24 (turning on or off). In this exemplary embodiment, the first switch 22 is a P-channel MOSFET (PMOS), and the second switch 24 is an N-channel MOSFET (NMOS); however, this is not a limitation in the present disclosure. The first switch 22 or the second switch 24 can be a transistor of other type, and the type of the first switch 22 and the second switch 24 is not limited in the present disclosure.

The control circuit 25 comprises a timer 251, which is utilized to determine a predetermined time interval. The frequency range that the human ear can hear is generally between 2 k Hz and 20 kHz. The frequency corresponding to the predetermined time interval is in the ultrasonic wave frequency range (e.g., greater than 20 kHz). For example, the predetermined time interval is set to 32 μsec. The frequency corresponding to 32 μsec is approximately 31 kHz, in which the sound the human ear cannot hear. The control circuit 25 detects whether the voltage at the phase node 203 is changed during a predetermined time interval. The voltage change of the phase node 203 is controlled by the change in conducting status of the first switch 22 and the second switch 24. When the DC-DC boost converter 2 operates in the pulse frequency modulation mode, the load is light load. Because the power consumed by the load is lower (relative to operating in the pulse width modulation mode), the second switch 24 and the first switch 22 are not switched when the output voltage Vout is still sufficiently large (which can be obtained by comparing the feedback voltage FB with a reference voltage Vref in the control circuit 25). When the DC-DC boost converter 2 operates in a conventional pulse frequency modulation mode, the frequency of the switching noise will be in a frequency range the human ear can hear if the frequency corresponding to the time interval between two switching of the second switch 24 (and the first switch 22) is lower than 20 kHz.

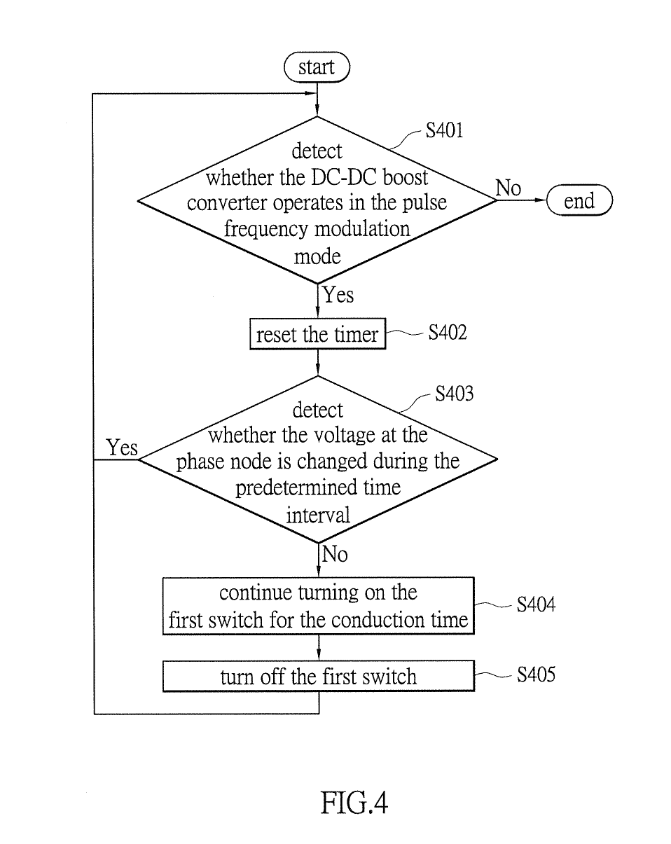

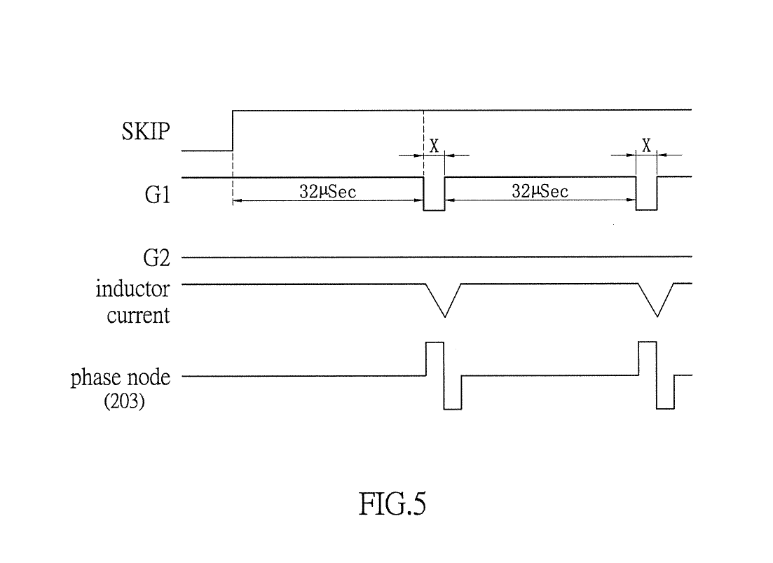

In the described predetermined time interval, when there is a voltage change at the phase node 203, it represents the first switch 22 or the second switch 24 is switched (from ON to OFF or OFF to ON) at the predetermined time interval, so the noise frequency generated by the first switch 22 or the second switch 24 is higher than 20 kHz and is too high to be heard by the human ear. In contrast, when the voltage at the phase node 203 is not changed at the predetermined time interval, the control circuit 25 continues turning on the first switch 22 for a conduction time X in the exemplary embodiment of the present disclosure. In other words, the control circuit 25 can at least turn on the first switch 22 every predetermined time interval so as to keep the frequency of the switching noise greater than the frequency the human ear can hear (i.e., greater than 20 kHz). To be described in more detail, please refer to the operation flow shown in FIG. 4 and FIG. 5.

Referring to FIG. 3, FIG. 4 and FIG. 5, FIG. 4 is an operation flow chart of a DC-DC boost converter in an embodiment of the present disclosure, and FIG. 5 is a waveform diagram of voltage and current during operation of a DC-DC boost converter in an embodiment of the present disclosure. First of all, at step S401 shown in FIG. 4, detect whether the DC-DC boost converter 2 operates in the pulse frequency modulation mode. If the DC-DC boost converter 2 does not operate in the pulse frequency modulation mode, the control circuit 25 operates conventionally, for example, operates in the pulse width modulation mode, but it is not limited to this in the present disclosure. If the DC-DC boost converter 2 operates in the pulse frequency modulation mode, then proceed to step S402. For example, a signal SKIP shown in FIG. 5 represents the feedback voltage FB is greater than the reference voltage Vref in the control circuit 25 when operating in the pulse frequency modulation mode. At step S402, reset the timer 251. The timer 251 starts to count a time. For example, the timer 251 counts 32 μsec.

After that, proceed to step S403. At step S403, detect whether the voltage at the phase node 203 is changed during the predetermined time interval. If there is a voltage change at the phase node 203 during the predetermined time interval, then proceed to step S401 again. As the first switch 22 (or the second switch 24) performs a switching action, the frequency of the switching noise will be in a frequency range the human ear cannot hear (greater than 20 kHz). It is worth mentioning that if the first switch 22 (or the second switch 24) performs a switching action during the predetermined time interval, it represents the voltage level of the output voltage Vout is insufficient and the capacitor 23 needs to be supplied power. In this situation, the switching principle of the first switch 22 and the second switch 24 utilizes conventional pulse frequency modulation technology, and thus will not be further described hereinafter.

In contrast, if the voltage at the phase node 203 is not changed at the predetermined time interval, then proceed to step S404. At step S404, continue turning on the first switch 22 for the conduction time X. As shown in FIG. 5, after counting 32 μsec, the voltage at the control node G1 of the first switch 22 changes and keeps for the conduction time X. After that, at step S405; turn off the first switch 22. After step S405, proceed to step S401 again and repeat the above-mentioned flow.

It is worth mentioning that during the process that the first switch 22 is turned on and keeps turned on for the conduction time X, the energy of the output voltage node 202 flows to the input voltage node 201 via the inductor 21, and it represents some energy of the output voltage node 202 (or the capacitor 23) is released to the input voltage node 201. During the above-mentioned energy releasing process, as long as the output voltage Vout can keep greater than the voltage level set by the DC-DC boost converter 2 (the control circuit 25 detects it through detecting the feedback voltage FB), the second switch 24 will not be switched. As shown in FIG.5, the voltage at the control node G2 of the second switch 24 is not changed.

In other words, as long as the DC-DC boost converter 2 operates in the pulse frequency modulation mode, the control circuit 25 can at least turn on the first switch 22 every predetermined time interval (e.g., 32 μsec) so as to keep the frequency of the switching noise greater than 20 kHz.

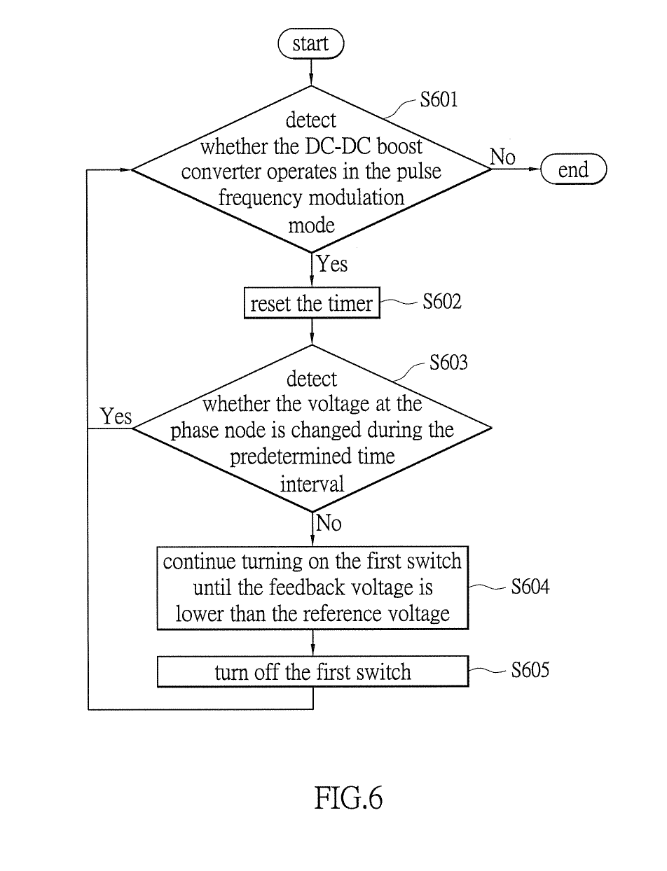

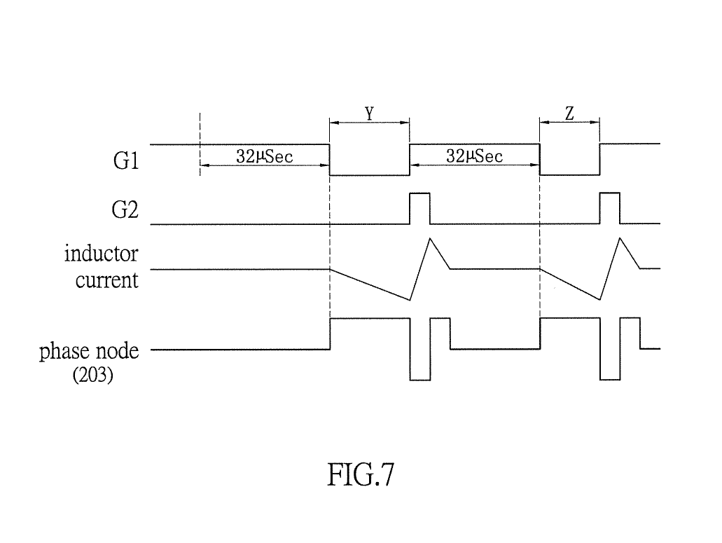

Referring to FIG. 3, FIG. 6 and FIG. 7, FIG. 6 is an operation flow chart of a DC-DC boost converter in another embodiment of the present disclosure, and FIG. 7 is a waveform diagram of voltage and current during operation of a DC-DC boost converter in another embodiment of the present disclosure. In this exemplary embodiment, the structure of the DC-DC boost converter 2 does not change, but only the time the control circuit 25 turns on the first switch 22 is changed. In detail, the steps S401 to S405 in the previous exemplary embodiment are replaced with the steps S601 to S605 in FIG. 6. Above all, at step S601, detect whether the DC-DC boost converter 2 operates in the pulse frequency modulation mode. Step S601 is same as step S401. Next, at step S602 reset the timer 251. The timer 251 starts to count a time. Step S602 is same as step S402 as well. Next, at step S603, detect whether the voltage at the phase node 203 is changed during the predetermined time interval. Step S603 is same as step S403 as well. Please refer to the description of the previous exemplary embodiment.

After that, if the voltage at the phase node 203 is not changed at the predetermined time interval, then proceed to step S604. At step S604, continue turning on the first switch 22 until the feedback voltage FB is lower than the reference voltage Vref. When the feedback voltage FB is lower than the reference voltage Vref, it represents the voltage level of the output voltage Vout is insufficient and the capacitor 23 needs to be charged. The reference voltage Vref corresponds to the output voltage Vout set by the DC-DC boost converter 2. When the capacitor 23 needs to be charged, the second switch 24 will be turned on. As shown in FIG. 7, the time period of continuing turning on the first switch 22 until the feedback voltage FB is lower than the reference voltage Vref at step S604 is related to the voltage level of the output voltage Vout and the setting of the reference voltage Vref. The more energy the capacitor 23 stores, the longer the first switch 22 is turned on. Therefore, as shown in FIG. 7, a conduction time Y and a conduction time Z of the first switch 22 may vary with the amount of energy stored in the capacitor 23 before switching on the first switch 22.

After that, as the output voltage Vout is lower than the voltage level set by the DC-DC boost converter 2 (the control circuit 25 detects it through detecting the feedback voltage FB), the second switch 24 will be switched on after switching off the first switch 22 (step S605). It is worth mentioning that, after switching off the first switch 22 (step S605), the switching action of the second switch 24 being turned on is controlled by the control circuit 25 utilizing conventional pulse frequency modulation technology.

In other words, as long as the DC-DC boost converter 2 operates in the pulse frequency modulation mode, the control circuit 25 can at least turn on the first switch 22 every predetermined time interval (e.g., 32 μsec) and keeps the conducting status of the first switch 22 until the output voltage Vout is lower than the voltage level set by the DC-DC boost converter 2 (for example, the output voltage Vout is equal to the input voltage Vin), and thereby the switch of the control circuit 25 is at least turned on every predetermined time interval so as to keep the frequency of the switching noise greater than 20 kHz.

Referring again to FIG. 3. The control circuit 25 shown in FIG. 3 not only can detect whether the voltage at the phase node 203 is changed during the predetermined time interval through to decide whether to turn on the first switch 22 (it means the first switch 22 is switched once), but also can detect whether the conducting status of the second switch 24 is changed during the predetermined time interval (at least once) to decide whether to turn on the first switch 22. When the conducting status of the second switch 24 is not changed during the predetermined time interval, the control circuit 25 turns on the first switch 22. It is worth mentioning that, in this exemplary embodiment, the control circuit 25 is not required to be coupled to the phase node 203.

In detail, the control circuit 25 may continue turning on the first switch 22 for a conduction time X or continue turning on the first switch 22 until the feedback voltage FB is lower than the reference voltage Vref. That is to say, the step S403 in FIG. 4 and the step S603 in FIG. 6 are changed to detect whether the conducting status of the second switch 24 is changed during the predetermined time interval. In other words, when the conducting status of the second switch 24 is changed during the predetermined time interval, the voltage at the phase node 203 is changed as well. This exemplary embodiment provides another implementation method of detection mechanism for the control circuit 25.

To sum up the above description, the exemplary embodiment of the present disclosure provides a DC-DC boost converter, which detects whether the voltage at a phase node is changed during a predetermined time interval. When the voltage at the phase node is not changed during the predetermined time interval, it represents a first switch and a second switch of the DC-DC boost converter are not switched (the conducting statuses are not changed) during the predetermined time interval, the control circuit turns on the first switch so as to avoid generating the noise in the frequency that the human ear can hear during operation of the DC-DC boost converter. Through a timer, the control circuit can turn on the first switch for a predetermined conduction time when the predetermined time interval is reached. Or, the control circuit can continues turning on the first switch until an output voltage is lower than a voltage level set by the DC-DC boost converter when the predetermined time interval is reached.

The above-mentioned descriptions represent merely the exemplary embodiment of the present disclosure, without any intention to limit the scope of the present disclosure thereto.

What is claimed is:

1. A DC-DC boost converter, operating in a pulse frequency modulation mode, comprising:
an inductor, coupled between an input voltage node and a phase node;
a first switch, coupled between the phase node and an output voltage node;
a capacitor, coupled between the output voltage node and a ground;
a second switch, coupled between the phase node and the ground; and
a control circuit, controlling the conducting status of the first switch and the second switch according to a feedback voltage responding to the voltage at the output voltage node;
wherein the control circuit detects whether the voltage at the phase node is changed during a predetermined time interval; when the voltage at the phase node is not changed during the predetermined time interval, the control circuit continues turning on the first switch for a conduction time.

2. The DC-DC boost converter according to claim 1, wherein the control circuit further comprises a timer; the timer is configured to determine the predetermined time interval.

3. The DC-DC boost converter according to claim 1, wherein the frequency corresponding to the predetermined time interval is in the ultrasonic wave frequency range.

4. The DC-DC boost converter according to claim 1, wherein the first switch is a P-channel MOSFET (PMOS).

5. The DC-DC boost converter according to claim 1, wherein the second switch is an N-channel MOSFET (NMOS).

6. The DC-DC boost converter according to claim 1, further comprising:
a voltage division unit, coupled to the output voltage node, generating the feedback voltage according to the voltage at the output voltage node.

7. A DC-DC boost converter, operating in a pulse frequency modulation mode, comprising:
an inductor, coupled between an input voltage node and a phase node;
a first switch, coupled between the phase node and an output voltage node;
a capacitor, coupled between the output voltage node and a ground;
a second switch, coupled between the phase node and the ground; and
a control circuit, controlling the conducting status of the first switch and the second switch according to a feedback voltage responding to the voltage at the output voltage node;
wherein the control circuit detects whether the voltage at the phase node is changed during a predetermined time interval; when the voltage at the phase node is not changed during the predetermined time interval, the control circuit continues turning on the first switch until the feedback voltage is lower than a reference voltage.

8. The DC-DC boost converter according to claim 7, wherein the control circuit further comprises a timer; the timer is configured to determine the predetermined time interval.

9. The DC-DC boost converter according to claim 7, wherein the frequency corresponding to the predetermined time interval is in the ultrasonic wave frequency range.

10. The DC-DC boost converter according to claim 7, wherein the first switch is a P-channel MOSFET (PMOS).

11. The DC-DC boost converter according to claim 7, wherein the second switch is an N-channel MOSFET (NMOS).

12. The DC-DC boost converter according to claim 7, further comprising:
a voltage division unit, coupled to the output voltage node, generating the feedback voltage according to the voltage at the output voltage node.

13. A DC-DC boost converter, operating in a pulse frequency modulation mode, comprising:
an inductor, coupled between an input voltage node and a phase node;
a first switch, coupled between the phase node and an output voltage node;
a capacitor, coupled between the output voltage node and a ground;
a second switch, coupled between the phase node and the ground; and
a control circuit, controlling the conducting status of the first switch and the second switch according to a feedback voltage responding to the voltage at the output voltage node;
wherein the control circuit detects whether the conducting status of the second switch is changed during a predetermined time interval; when the conducting status of the second switch is not changed during the predetermined time interval, the control circuit turns on the first switch.

14. The DC-DC boost converter according to claim 13, wherein when the conducting status of the second switch is not changed during the predetermined time interval, the control circuit continues turning on the first switch for a conduction time.

15. The DC-DC boost converter according to claim 13, wherein when the conducting status of the second switch is not changed during the predetermined time interval, the control circuit continues turning on the first switch until the feedback voltage is lower than a reference voltage.

16. The DC-DC boost converter according to claim 13, wherein the control circuit further comprises a timer; the timer is configured to determine the predetermined time interval.

17. The DC-DC boost converter according to claim 13, wherein the frequency corresponding to the predetermined time interval is in the ultrasonic wave frequency range.
